(19) United States
(12) Patent Application Publication
(10) Pub. No.: US 2019/0132910 A1
(43) Pub. Date: May 2, 2019

(54) TOOL ARCHITECTURE USING VARIABLE FREQUENCY MICROWAVE FOR RESIDUAL MOISTURE REMOVAL OF ELECTRODES

(71) Applicant: Applied Materials, Inc., Santa Clara, CA (US)

(72) Inventors: Jean DELMAS, Santa Clara, CA (US); Brian H. BURROWS, San Jose, CA (US); Subramanya P. HERLE, Mountain View, CA (US)

(21) Appl. No.: 16/114,790

(22) Filed: Aug. 28, 2018

Related U.S. Application Data
(60) Provisional application No. 62/580,565, filed on Nov. 2, 2017.

(51) Int. Cl. H05B 6/80; H01M 10/04

(52) U.S. Cl. CPC H05B 6/80; H01M 10/0431

(57) ABSTRACT

Implementations described herein generally relate to batteries for portable electronic devices. More specifically, implementations of the present disclosure relate to electrode assemblies, such as jelly roll-type electrode assemblies, and apparatus and methods for manufacturing electrode assemblies. In one implementation, a system for moisture removal is provided. The system comprises a tubular chamber body defining one or more processing regions. The tubular chamber body comprises a tubular outer wall and an interior wall that encloses an interior volume. The one or more processing regions include a pre-heat region and a drying region. The pre-heat region comprises a first variable frequency microwave source capable of producing microwave energy in a range from about 0.9 GHz to about 10 GHz. The drying region comprises a second variable frequency microwave source capable of producing microwave energy in a range from about 0.9 GHz to about 10 GHz and a vacuum source.

### CROSS-REFERENCE TO RELATED APPLICATIONS

This application claims benefit of U.S. Provisional Patent Application Ser. No. 62/580,565, filed Nov. 2, 2017, which is incorporated herein by reference in its entirety.

### BACKGROUND

### Field

Implementations described herein generally relate to batteries for portable electronic devices. More specifically, implementations of the present disclosure relate to jelly roll-type electrode assemblies, and apparatus and methods for manufacturing electrode assemblies, such as jelly roll-type electrode assemblies.

### Description of the Related Art

Rechargeable batteries are presently used to provide power to a wide variety of portable electronic devices, including laptop computers, cell phones, PDAs, digital music players and cordless power tools. The most commonly used type of rechargeable battery is a lithium battery, which can include a lithium-ion or a lithium-polymer battery.

Depending upon the shape of a battery case, a rechargeable battery may be classified as a cylindrical battery having an electrode assembly mounted in a cylindrical metal container, a prismatic battery having an electrode assembly mounted in a prismatic metal container, or a pouch-shaped battery having an electrode assembly mounted in a pouch-shaped case typically formed of an aluminum laminate sheet.

The electrode assembly mounted in the battery case is a power-generating element, having a cathode/separator/anode stack structure, which can be charged and discharged. The electrode assembly may be classified as a jelly roll-type electrode assembly having a structure in which a long sheet type cathode and a long sheet type anode, to which active materials are applied, are wound in a state in which a separator is disposed between the cathode and the anode. Alternatively, the electrode assembly may be classified as stacked-type electrode assemblies having a structure in which a plurality of cathodes has a predetermined size and a plurality of anodes having a predetermined size are sequentially stacked in a state in which separators are disposed respectively between the cathodes and the anodes. Alternatively, the electrode assembly may be further classified as a stacked/folded type electrode assembly having a structure in which a predetermined number of cathodes and a predetermined number of anodes are sequentially stacked in a state in which separators are disposed respectively between the cathodes and the anodes to constitute a unit cell, such as a bi-cell or a full cell, and then unit cells are wound using a separation film. The jelly roll-type electrode assembly has advantages in that the jelly roll-type electrode assembly is easy to manufacture and has high energy density per unit mass. However, as with all rechargeable batteries containing lithium, moisture contamination of the jelly roll-type electrode assembly has a deleterious effect on its operation.

Currently, jelly roll-type electrode assembly operations are usually performed in a dry room. Alternatively, the jelly roll-type electrode assembly may be put in a heated vacuum for a certain duration in order to extract residual water from the cell before filling with electrolyte. However, currently available production processes often fail to remove the required amount of moisture from the electrode assembly, which often leads to device failure. Among other problems and limitations of currently available production processes is the slow and costly drying component, which typically involves a large footprint and increases production time and cost.

Accordingly, there is a need in the art for systems and apparatus for more cost effectively manufacturing faster charging, higher capacity, energy storage devices that have reduce moisture content at a high production rate without detrimentally effecting the environment.

### SUMMARY

Implementations described herein generally relate to batteries for portable electronic devices. More specifically, implementations of the present disclosure relate to electrode assemblies, such as jelly roll-type electrode assemblies, and apparatus and methods for manufacturing electrode assemblies. In one implementation, a system for moisture removal is provided. The system comprises a tubular chamber body defining one or more processing regions. The tubular chamber body comprises a tubular outer wall and an interior wall that encloses an interior volume. The one or more processing regions include a pre-heat region and a drying region. The pre-heat region comprises a first variable frequency microwave source capable of producing microwave energy in a range from about 0.9 GHz to about 10 GHz. The drying region comprises a second variable frequency microwave source capable of producing microwave energy in a range from about 0.9 GHz to about 10 GHz and a vacuum source.

In another implementation, a method for processing a substrate is provided. The method comprises performing a pre-heat of a jelly roll-type electrode assembly in a pre-heat region of a tubular processing system. The pre-heat comprises directing a source of microwave radiation toward the jelly roll-type electrode assembly. The source of microwave radiation produces microwave radiation at a first frequency selected from a first frequency range of from about 0.9 GHz to about 10 GHz. The pre-heat further comprises delivering the microwave radiation at a first variable frequency from the source of the microwave radiation to the jelly roll-type electrode assembly to pre-heat the jelly roll-type electrode assembly to a pre-heat temperature, the first variable frequency comprising two or more frequencies selected from the first frequency range, the first variable frequency changing over a first period of time.

### BRIEF DESCRIPTION OF THE DRAWINGS

So that the manner in which the above-recited features of the present disclosure can be understood in detail, a more particular description of the implementations, briefly summarized above, may be had by reference to implementations, some of which are illustrated in the appended drawings. It is to be noted, however, that the appended drawings illustrate only typical implementations of this disclosure and are therefore not to be considered limiting of its scope, for the disclosure may admit to other equally effective implementations.

FIG. 1 is a schematic diagram showing one example of a jelly roll-type electrode assembly formed according to one or more implementations described herein;

FIG. 2 is a schematic view of a processing chamber according to one or more implementations described herein;

FIG. 3 is a schematic isometric view of one example of a substrate-processing system according to one or more implementations described herein;

FIG. 4 is a schematic plan view of one example of the substrate-processing system of FIG. 3 according to one or more implementations described herein;

FIG. 5 is a schematic plan view of another example of a substrate-processing system according to one or more implementations described herein; and

FIG. 6 is a flow diagram of a method for moisture removal using a variable frequency microwave according to one or more implementations described herein.

To facilitate understanding, identical reference numerals have been used, where possible, to designate identical elements that are common to the figures. It is contemplated that elements and features of one implementation may be beneficially incorporated in other implementations without further recitation.

### DETAILED DESCRIPTION

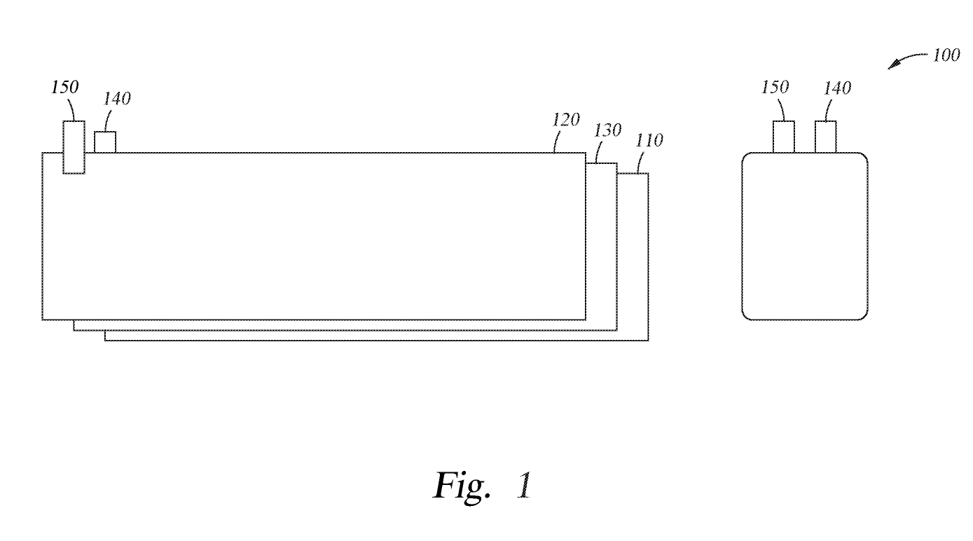

The following disclosure describes generally relate to electrode assemblies for batteries and apparatus and methods for manufacturing electrode assemblies. Certain details are set forth in the following description and in FIGS. 1-6 to provide a thorough understanding of various implementations of the disclosure. Other details describing well-known structures and systems often associated with electrode assemblies and moisture removal for electrode assemblies are not set forth in the following disclosure to avoid unnecessarily obscuring the description of the various implementations.

Many of the details, dimensions, angles and other features shown in the Figures are merely illustrative of particular implementations. Accordingly, other implementations can have other details, components, dimensions, angles and features without departing from the spirit or scope of the present disclosure. In addition, further implementations of the disclosure can be practiced without several of the details described below.

Implementations of the present disclosure generally provide a high throughput substrate-processing system, or cluster tool, for residual moisture removal from an electrode assembly, such as a jelly roll-type electrode assembly. In some implementations, the substrate-processing system combines a variable frequency microwave (VFM) source with a vacuum assisted environment and tubular chamber design to achieve improved moisture removal and higher throughput. The tubular chamber design is believed to improve vacuum compatibility. In some implementations, the walls of the tubular chamber are temperature controlled. In some implementations, dedicated chamber racks, which match the form factor of the tubular chamber design, are provided to transport one or more electrode assemblies through the substrate-processing system.

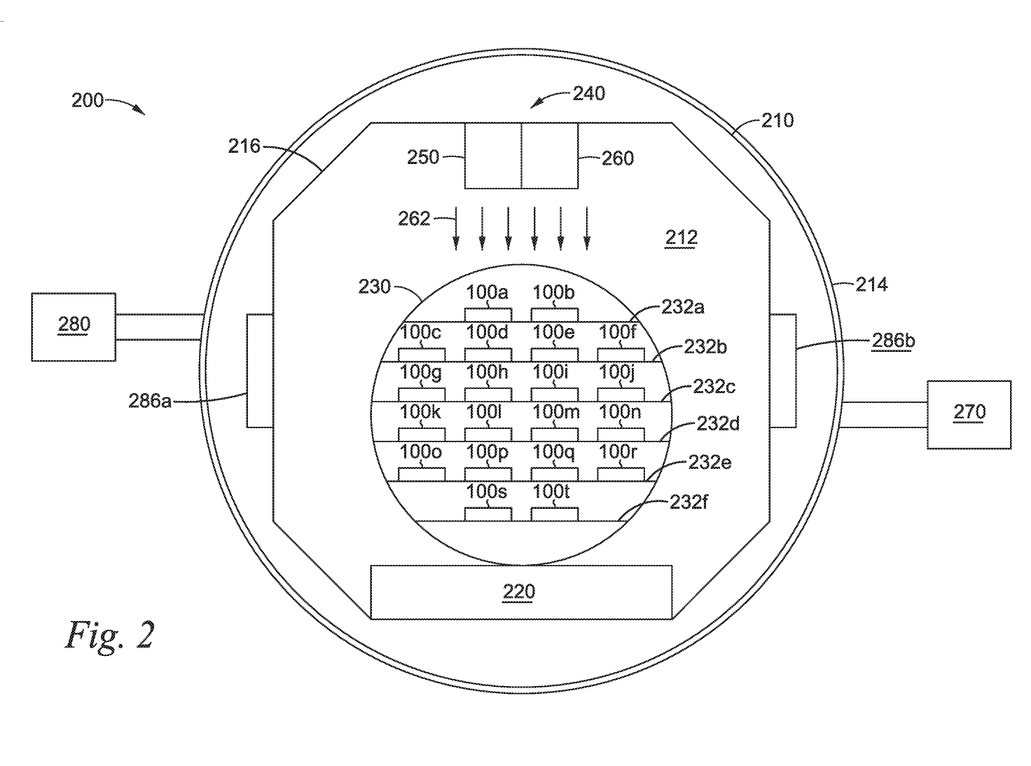

The high throughput substrate-processing system may include one or drying regions in which electrode assemblies are exposed to at least one or more high power VFM sources, one or more low power VFM sources, dry air, and a vacuum assisted environment. In one implementation, the substrate-processing system includes a front-end loading region for loading substrates into the substrate-processing system, a pre-heat region including a high power VFM source (e.g., 0.9 GHz to 10 GHz power) for preheating the substrates to a chosen temperature, a plurality of drying regions for removing moisture from the pre-heated substrates, and a back end loading region for removing the substrates from the substrate-processing system. In one implementation, the plurality of drying regions includes at least one low power VFM source (e.g., 0.9 GHz to 10 GHz power). In one implementation, the frequency range of the low power VFM source is in a range that is from about 10% to 20% of the frequency of the high power VFM source. In one implementation, the frequency range of the low power VFM source is split among multiple drying regions. In some implementations, the substrate-processing system has been adapted to simultaneously process a plurality of substrates as they pass through the system in a linear direction. In one implementation, the electrode assembly substrates are simultaneously transferred in a vacuum or inert environment through the linear system to improve substrate drying and throughput. In some implementations, the substrates are stacked both horizontally and vertically on dedicated racks, such as shown in FIG. 2, for drying as opposed to processing either vertical stacks of substrates or planar arrays of substrates that are typically transferred on a substrate carrier in a batch. Such drying of substrates arranged on dedicated racks allows each of the substrates to be directly and uniformly exposed to the VFM, radiant heat, and/or a vacuum environment.

Implementations of the of the present disclosure can be used to uniformly and rapidly dry electrode assemblies, such as jelly roll-type electrode assemblies shown in FIG. 1, in a high throughput substrate-processing system, such as the substrate-processing system that is illustrated in FIGS. 2-5 and further discussed below.

FIG. 1 is a schematic diagram showing one example of a jelly roll-type electrode assembly 100 that may be processed according to implementations described herein. The jelly roll-type electrode assembly 100 is obtained by winding a plurality of electrodes in a single direction. Two linear electrodes, that is, an anode 110 with an active coating and a cathode 120 with an active coating, both of which generally have a rectangular shape elongated in a single direction, and a separator 130 are used, as illustrated in FIG. 1. Therefore, the jelly roll-type electrode assembly 100, obtained as described above by laminating the anode 110 and the cathode 120 with the separator 130 disposed therebetween and simply winding the anode 110 and the cathode 120, and a battery obtained using such an electrode assembly typically has a rectangular shape as illustrated in FIG. 1. An anode tab 140 is coupled with the anode 110 and provides a negative terminal for the jelly roll-type electrode assembly 100. A cathode tab 150 is coupled with the cathode 120 and provides a positive terminal for the jelly roll-type electrode assembly 100.

The jelly roll-type electrode assembly 100 is formed by winding a laminate in a single direction. The laminate is formed by laminating the anode 110 and the cathode 120 with a separator 130 disposed therebetween. The anode 110 includes an anode active material layer in which one surface or both surfaces of an anode collector plate are coated with an anode active material. The cathode 120 includes a cathode active material layer in which one surface or both surfaces of a cathode collector plate are coated with a cathode active material. Jelly roll-type electrodes are well known in the art and will not be discussed further.

FIG. 2 is a schematic view of a substrate-processing region 200 or chamber according to one or more implementations described herein. The substrate-processing region 200 includes a tubular chamber body 210 that encloses an interior volume 212. In some implementations, the tubular chamber body 210 is defined by an outer wall 214 and an interior wall 216. In some implementations, the outer wall 214 is a tubular outer wall. In some implementations, the interior wall 216 is an octagonal interior wall. Although shown as an octagonal interior wall, interior wall 216 may have other shapes (e.g., circular, hexagonal, etc.). In one implementation, the tubular chamber body 210 is fabricated from standard materials, such as aluminum, quartz, ceramic or stainless steel. In one implementation, the tubular chamber body 210 is fabricated from welded plates of stainless steel or a unitary block of aluminum. The tubular chamber body 210 defines one or more processing regions.

The substrate-processing region 200 includes a substrate automation system 220 for transporting the jelly roll-type electrode assemblies 100 through the one or more processing regions of the substrate-processing region 200. The substrate automation system 220 comprises one or more conveyors configured to transfer one or more substrates through the interior volume 212 of the substrate-processing region 200. The substrate automation system 220 typically extends along a longitudinal axis of the tubular chamber body for transferring one or more substrates between the one or more processing regions. In one implementation, the substrate automation system 220 is a stop and go conveyor. In another implementation, the substrate automation system 220 comprises one or more roller or belt conveyors.

During processing, the substrate-processing region 200 includes a substrate carrier 230 for carrying a plurality of electrode assemblies, such as jelly roll-type electrode assemblies 100a-100t (collectively 100) The substrate carrier 230 may be fabricated from any suitable material with low thermal mass that will not heat more than the jelly roll-type electrode assemblies will. In one implementation, the substrate carrier 230 is fabricated from a material that is transparent to microwaves. In one implementation, the substrate carrier 230 is fabricated from quartz. In one implementation, the substrate carrier 230 has a cylindrical shape. In one implementation, the substrate carrier 230 includes a plurality of racks 232a-232f (collectively 232) for supporting the jelly roll-type electrode assemblies 100a-100t.

The substrate-processing region 200 may further include a variable frequency microwave radiation source 240. In one implementation, the variable frequency microwave radiation source 240 is a high power VFM source. In another implementation, the variable frequency microwave radiation source 240 is a low power VFM source. The variable frequency microwave radiation source 240 can include a microwave power source 250. The microwave power source 250 can be selected from all available microwave power sources, including magnetrons, klystrons, gyrotrons, and traveling wave tubes. The variable frequency microwave radiation source 240 can also include a microwave cavity 260. The microwave cavity 260 can be a single mode, multi-mode cavity or combinations thereof. The microwave cavity 260 can receive power from the microwave power source 250.

In some implementations, the variable frequency microwave radiation source 240 is positioned external to the substrate-processing region 200. In some implementations where the variable frequency microwave radiation source 240 is positioned external to the substrate-processing region 200, the variable frequency microwave radiation source 240 is coupled with the substrate-processing region 200 via a waveguide. In some implementations, the tubular chamber body includes one or more injection points (e.g., waveguides) to ensure a uniformity and sufficient energy distribution in the substrate-processing region 200.

The variable frequency microwave energy 262 can include continuous sweeping of frequencies over the available frequency range. Continuous sweeping can prevent charge buildup in metal layers, thus reducing the potential for arcing and subsequent damage. Frequency sweeping is often carried out by selecting a center frequency and then rapidly sweeping the frequency in a substantially continuous way over some range. Typically, frequency sweeping can include frequencies in the range of +/−5% of the center frequency, although this range can vary depending on such factors as the type of microwave source and the overall size of the cavity compared to the microwave wavelength.

In one implementation, the frequency range of the variable frequency microwave energy 262 can be a specific range of frequencies, such as a range from about 0.9 GHz to about 10 GHz, for example, from about 5.85 GHz to 7.0 GHz, such as from about 5.85 GHz to about 6.65 GHz. In one implementation, the variable frequency microwave energy 262 is in the range of from about 5850 MHz to about 6650 MHz. Further, the frequency range can be partitioned into frequencies of a specific interval from one another, such as frequencies selected to be separated by from 200 Hz to 280 Hz. In one implementation, a 260 Hz separation in frequencies selected from the variable frequency microwave energy can be used, creating 4096 selected frequencies from which the variable frequency microwave energy 262 can be selected. In another implementation, the frequency range of the variable frequency microwave energy 262 can be a specific range of frequencies, such as a range from about 0.09 GHz to about 0.10 GHz, for example, from about 0.58 GHz to about 0.7 GHz, such as from about 0.58 GHz to about 0.67 GHz. Further, the variable frequency microwave energy 262 delivered during the frequency sweeping can be delivered to the jelly roll-type electrode assemblies 100a-100t in short bursts of each frequency range selected, such as short bursts of 20 microseconds to 30 microseconds per frequency, for example 25 microseconds.

The substrate-processing region 200 can further include a gas source 270. In one implementation, the gas source 270 delivers an inert gas, such as a gas comprising argon or helium to the interior volume 212. In one implementation, the gas source 270 delivers heated air to the interior volume 212. The gas source 270 can deliver gas to the chamber at a specified flow rate based on the size of the processing region and the size of the substrate being processed. The gas source 270 can be directly connected with the substrate-processing region 200 or indirectly delivered to the substrate-processing region 200. In one implementation, the gas source is heated to deliver heated gas over the jelly roll-type electrode assemblies 100a-100t. In one implementation, the gas source 270 can be positioned to deliver heated gas over the jelly roll-type electrode assemblies 100a-100t to heat the jelly roll-type electrode assemblies 100a-100t. In one implementation, the gas source 270 delivers heated air to the interior volume 212. The flow of heated air may be delivered to the interior volume 212 to evaporate some or all of the residual moisture from the jelly roll-type electrode assemblies 100a-100t.

The substrate-processing region 200 can also have one or more additional heat sources 286a, 286b (collectively 286), such as the heat source 286 depicted in FIG. 2 as being embedded in the walls of the tubular chamber body 210. Though the heat source 286 is depicted in FIG. 2 as being a resistive heat source embedded in the walls of the tubular chamber body 210, the heat source 286 may be any heat source applicable to removing residual moisture, such as an infrared heat lamp heat source. The heat from the heat source 286 may be delivered directly to the substrate carrier 230 or indirectly by changing the temperature of the substrate-processing region 200. The heat source 286 can be designed to heat and maintain the electrode assemblies at a stable temperature, such as a temperature in the range of about 50 degrees Celsius to about 150 degrees Celsius, such as in the range of about 50 degrees Celsius to about 100 degrees Celsius, for example, in the range of about 90 degrees Celsius to about 100 degrees Celsius. The heat source may be of any design and positioned in any position, which will allow energy to be delivered for heating the electrode assemblies.

The substrate-processing region 200 further includes a vacuum source 280. The vacuum source 280 can be applied to both maintain a vacuum, such as during a pre-heat and/or residual moisture removal process. In one implementation, the vacuum source 280 maintains the substrate-processing region 200 at a moderate vacuum level during processing. In one implementation, the vacuum source 280 maintains the substrate-processing region 200 at a vacuum level from about 0.1 Torr to about 500 Torr, for example, from about 0.1 Torr to about 10 Torr, such as about 200 Torr to about 500 Torr. In one implementation, the vacuum source 280 maintains the substrate-processing region 200 at a vacuum level from about 0.1 Torr to about 10 Torr, for example, from about 2 Torr to about 10 Torr, such as from about 5 Torr to about 20 Torr when the microwave source is off. In one implementation, the vacuum source 280 maintains the substrate-processing region 200 at a vacuum level from about 200 Torr to about 500 Torr, for example, from about 200 Torr to about 400 Torr, such as from about 250 Torr to about 350 Torr when the microwave source is on.

The substrate-processing region 200 can be fluidly connected to one or more processing regions, such as a pre-heat region or a drying region. The substrate-processing region 200 may also be part of a multi-chamber unit (not shown) which includes drying regions. Using a fluid connection between regions, helps prevent further accumulation of H₂O and other impurities.

It is important to note that, though implementations described herein focus on residual moisture removal for jelly roll-type electrode assemblies, implementations described herein are equally applicable to other types of electrode assemblies that may benefit from residual moisture removal.

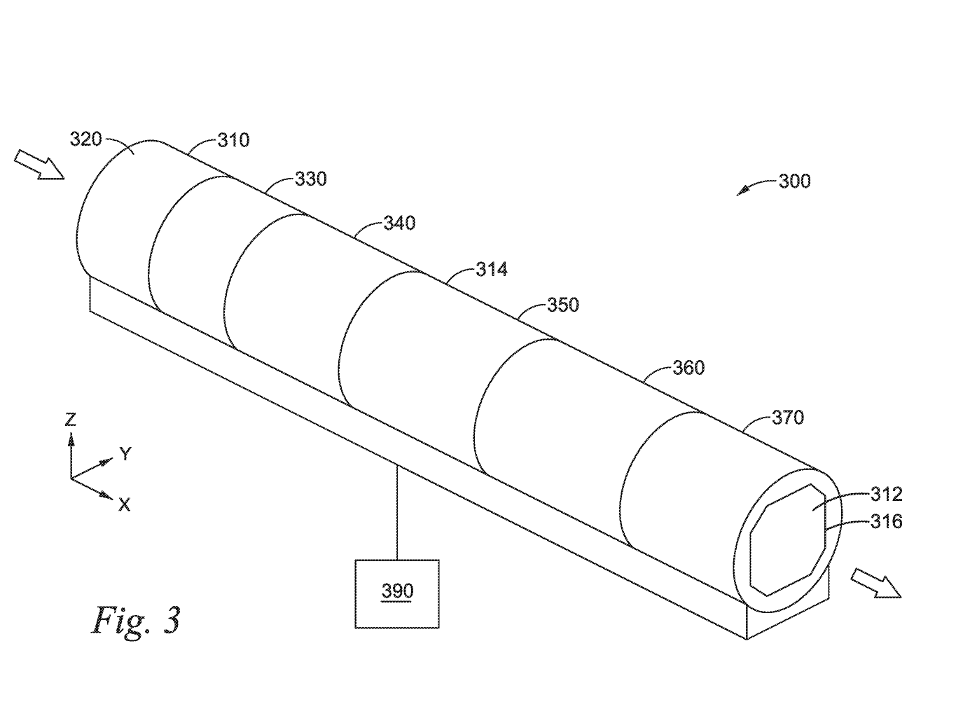

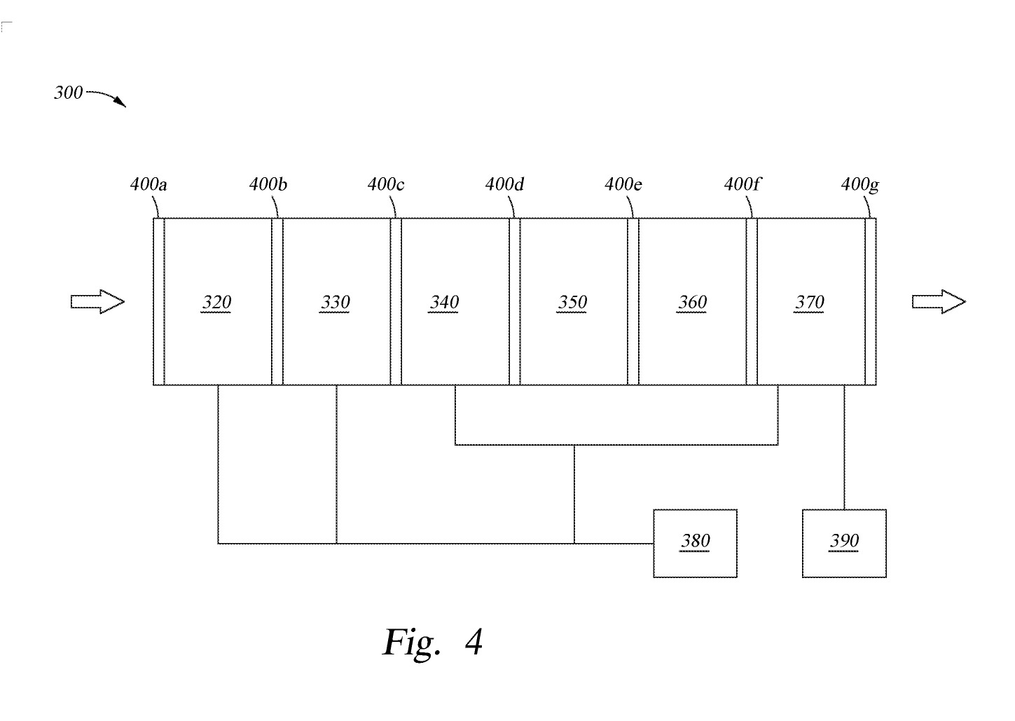

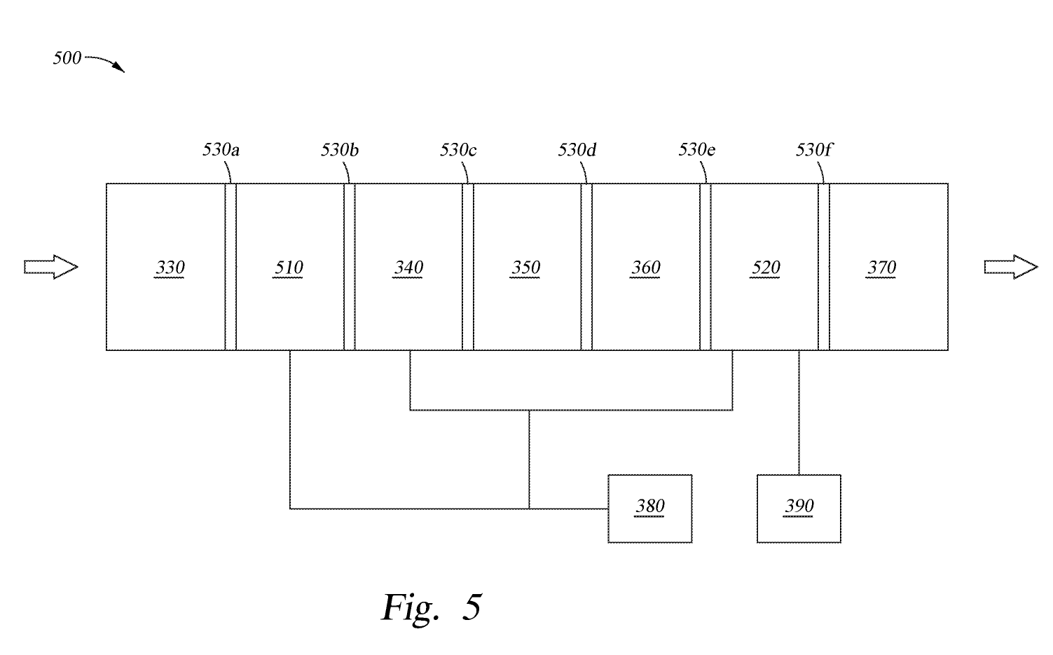

FIG. 3 is a schematic isometric view of one example of a substrate-processing system 300 according to one or more implementations described herein. FIG. 4 is a schematic plan view of one example of the substrate-processing system 300 of FIG. 3 according to one or more implementations described herein. In some implementations, the substrate-processing system 300 includes a version of the substrate-processing region 200. The substrate-processing system 300 is divided into a plurality of regions. The regions may be separated from each other by gate valves. In one implementation, the substrate-processing system 300 includes a substrate-receiving region 320, a pre-heat region 330, at least one drying region, such as a first drying region 340, a second drying region 350, a third drying region 360, and a substrate unload region 370. Although three drying regions are shown, it should be understood that any number of drying regions may be used. In some implementations, the number of drying regions is based on the amount of moisture to be removed from the electrode assemblies and sought after throughput through the substrate-processing system. FIGS. 4 and 5, which are further discussed below, each illustrate some alternate configurations of the substrate-processing system 300 according to some implementations of the present disclosure.

The substrate-processing system 300 includes a tubular chamber body 310 that encloses an interior volume 312. In some implementations, the tubular chamber body 210 is defined by an outer wall 314 and an interior wall 316. In some implementations, the outer wall 314 is a tubular outer wall. In some implementations, the interior wall 316 is an octagonal interior wall. Although shown as an octagonal interior wall, interior wall 316 may have other shapes (e.g., circular, hexagonal, etc.). In one implementation, the tubular chamber body 310 is fabricated from standard materials, such as aluminum, quartz, ceramic or stainless steel. In one implementation, the tubular chamber body 310 is fabricated from welded plates of stainless steel or a unitary block of aluminum.

In certain implementations, as illustrated in FIG. 3, the substrate-processing system 300 has the interior volume 312 through which the substrates are transferred during processing in a direction from the substrate-receiving region 320 to the substrate unload region 370 using a substrate automation system, such as substrate automation system 220 (FIG. 2).

In one implementation, the substrate-receiving region 320 comprises a substrate automation system, such as substrate automation system 220, configured to receive a substrate carrier, such as substrate carrier 230, so that the substrate carrier can be transferred through the various processing chambers found in the substrate-processing system 300. In operation, a substrate carrier loaded with electrode assemblies, such as jelly roll-type electrode assemblies, is loaded onto the substrate automation system in the substrate-receiving region 320. The substrate automation system 220 transfers the substrate carrier into the pre-heat region 330 where the jelly roll-type electrode assemblies are exposed to a pre-heat process.

In one implementation, the pre-heat region 330 includes a variable frequency microwave radiation source, such as the variable frequency microwave radiation source 240. In one implementation, the variable frequency microwave radiation source is a high power VFM source. In one implementation, the pre-heat region is the substrate-processing region 200. In one implementation, the pre-heat region 330 is maintained at a vacuum level (e.g., from about 200 Torr to about 500 Torr) during processing. After pre-heating the electrode assemblies, the substrate automation system 220 transfers a substrate carrier, such as substrate carrier 230 loaded with jelly roll-type electrode assemblies, into the first drying region 340 for removal of moisture from the electrode assemblies.

In one implementation, the first drying region 340 includes a variable frequency microwave radiation source, such as the variable frequency microwave radiation source 240. In one implementation, the variable frequency microwave radiation source of the first drying region 340 is a low power VFM source. In one implementation, the first drying region 340 includes a heated gas source, such as the gas source 270, for delivering heated air into the first drying region 340 for evaporating some or all of the residual moisture from the jelly roll-type electrode assemblies 100a-100t. In one implementation, the first drying region 340 is the substrate-processing region 200. In one implementation, the first drying region 340 is maintained at a vacuum level (e.g., from about 200 Torr to about 500 Torr) during processing. After drying the electrode assemblies, the substrate automation system 220 transfers the substrate carrier into the second drying region 350 for removal of moisture from the electrode assemblies.

In one implementation, the second drying region 350 includes a variable frequency microwave radiation source, such as the variable frequency microwave radiation source 240. In one implementation, the variable frequency microwave radiation source of the second drying region 350 is a low power VFM source. In one implementation, the second drying region 350 includes a heated gas source, such as the gas source 270, for delivering heated air into the second drying region 350 for evaporating some or all of the residual moisture from the jelly roll-type electrode assemblies 100a-100t. In one implementation, the second drying region 350 is the substrate-processing region 200. In one implementation, the second drying region 350 is maintained at a vacuum level (e.g., from about 200 Torr to about 500 Torr) during processing. After drying the electrode assemblies, the substrate automation system 220 transfers the substrate carrier into the third drying region 360 for removal of moisture from the electrode assemblies.

In one implementation, the third drying region 360 includes a variable frequency microwave radiation source, such as the variable frequency microwave radiation source 240. In one implementation, the variable frequency microwave radiation source of the third drying region 360 is a low power VFM source. In one implementation, the third drying region 360 includes a heated gas source, such as the gas source 270, for delivering heated air into the third drying region 360 for evaporating some or all of the residual moisture from the jelly roll-type electrode assemblies 100a-100t. In one implementation, the third drying region 360 is the substrate-processing region 200. In one implementation, the third drying region 360 is maintained at a vacuum level (e.g., from about 0.1 Torr to about 500 Torr) during processing. After drying the electrode assemblies, the substrate automation system 220 transfers the substrate carrier into the substrate unload region 370 for removal of moisture from the jelly roll-type electrode assemblies.

In one implementation, the substrate unload region 370 comprises the substrate automation system, such as substrate automation system 220, configured to transfer the substrate carrier, such as substrate carrier 230, so that the substrate carrier 230 can be removed from the substrate-processing system 300. In operation, the substrate carrier loaded with electrode assemblies is removed from the substrate automation system in the substrate unload region 370.

In one implementation, the processing regions 320-370 disposed in the substrate-processing system 200 are selectively isolated from each other by use of gate valve assemblies 400a-400g (collectively 400; see FIG. 4), which are discussed below. Each gate valve assembly 400 is configured to selectively isolate the processing regions 320-370 from the substrate automation system 220 and is disposed adjacent to the interface between the processing regions 320-370 and the substrate automation system 220. In one implementation, the substrate automation system 220 is maintained within a vacuum environment to eliminate or minimize pressure differences between the processing regions 320-370, which are typically used to process the substrates under a vacuum condition. However, in an alternate implementation, the individual processing regions 320-370 may be used to process the substrates in a clean and inert atmospheric pressure environment.

The substrate-processing system 300 further includes a vacuum source 380. The vacuum source 380 can be applied to both maintain a vacuum, such as during a pre-heat and/or residual moisture removal process. In one implementation, the vacuum source 280 maintains the substrate-processing system 300 at a moderate vacuum level (e.g., 1-100 mTorr) during processing.

Generally, the substrate-processing system 300 includes a system controller 390 configured to control the automated aspects of the system. The system controller 390 facilitates the control and automation of the overall substrate-processing system 300 and may include a central processing unit (CPU) (not shown), memory (not shown), and support circuits (or I/O) (not shown). The CPU may be one of any form of computer processors that are used in industrial settings for controlling various chamber processes and hardware (e.g., conveyors, motors, fluid delivery hardware, etc.) and monitor the system and chamber processes (e.g., substrate position, process time, detector signal, etc.). The memory is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits are also connected to the CPU for supporting the processor in a conventional manner. The support circuits may include cache, power supplies, clock circuits, input/output circuitry, subsystems, and the like. A program (or computer instructions) readable by the system controller 390 determines which tasks are performable on a substrate. Preferably, the program is software readable by the system controller 390, which includes code to generate and store at least substrate positional information, the sequence of movement of the various controlled components, and any combination thereof.

FIG. 5 is a schematic plan view of another example of a substrate-processing system 500 according to one or more implementations described herein. The substrate-processing system 500 is similar to the substrate-processing system 300. In the substrate-processing system 500, the pre-heat region 330 is positioned as the first region where the substrate carrier is input into the system. The substrate-processing system 500 further includes a first load lock region 510 and a second load lock region 520. The first load lock region 510 is positioned after the pre-heat region 330 and prior to the first drying region 340.

Regardless of the direction in which the substrates carrier is transferred, a function of the load lock regions 510, 520 is to continuously transport the substrate carrier to the first drying region 340 or from the third drying region 360, while eliminating the flow of gases from an atmospheric pressure side of the load lock regions 510, 520 to the vacuum conditions inside the drying regions 340-360. In one implementation, the load lock regions 510, 520 are configured into a plurality of discrete volumes that are moveable along a linear path between the atmospheric side of the load lock regions 510, 520 and the vacuum conditions inside the drying regions 340-360 as the substrate carrier, disposed within these discrete volumes, are transported therebetween. In some implementations, the pressure in the discrete volumes are separately reduced to staged levels as they are transferred along the substrate transfer path during the substrate transfer process. The division between the discrete volumes is provided by separation mechanisms disposed on a continuously moving, substrate automation system, which transports the substrate carrier between the atmospheric side of the load lock regions 510, 520 and the one or more drying regions 340-360.

In one implementation, the first load lock region 510 is selectively isolated from the pre-heat region 330 and the first drying region 340 via gate valve assemblies 530a, 530b respectively. In one implementation, the second load lock region 520 is selectively isolated from the third drying region 360 and the substrate unload region 370 via gate valve assemblies 530e, 530f respectively. In one implementation, the second drying region 350 is selectively isolated from the first drying region 340 and the third drying region via gate valve assemblies 530c, 530d respectively. In some implementations, gate valve assemblies 530c, 530d are replaced with microwave gate assemblies, which are not vacuum tight. Each gate valve assembly 530a-530f (collectively 530) is configured similarly to gate valve assembly 400.

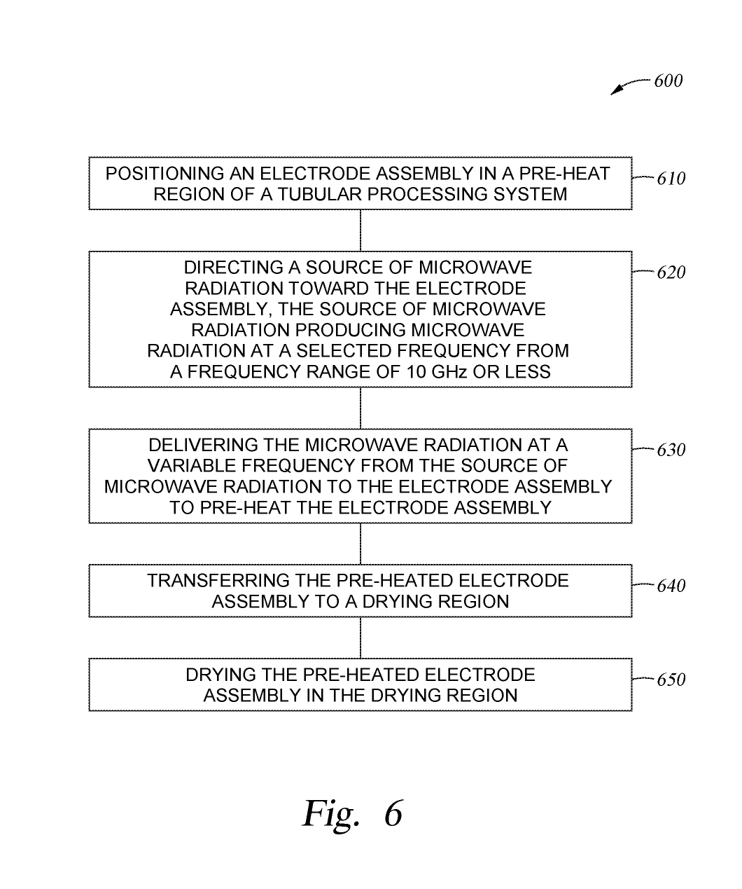

FIG. 6 is a flow diagram of a method 600 for moisture removal using a variable frequency microwave according to one or more implementations described herein. The method 600 may be used to remove moisture from an electrode assembly. The electrode assembly may be a jelly roll-type electrode assembly, such as the jelly roll-type electrode assembly 100 depicted in FIG. 1. The method 600 can be performed on other electrode assemblies that may benefit from moisture removal. The method 600 may be performed using any of the substrate-processing systems depicted herein.

At operation 610, an electrode assembly is positioned in a pre-heat region of a tubular processing system. In one implementation, the pre-heat region is pre-heat region 330. In one implementation, the tubular processing system is the substrate-processing system 300 or the substrate-processing system 500. In one implementation, the environment of the pre-heat region is maintained as a vacuum environment during the pre-heat process. In one implementation, the pre-heat region is maintained at a moderate vacuum level (e.g., 1-100 mTorr) during processing. In one implementation, the environment of the pre-heat region is maintained as an inert atmospheric pressure environment. The method 600 can begin by positioning a substrate in a processing chamber. In one implementation, the electrode assembly includes multiple electrode assemblies positioned on a substrate carrier, such as substrate carrier 230, and the substrate carrier is positioned in the pre-heat region.

At operation 620, a source of microwave radiation can be directed toward the electrode assembly. The source of microwave radiation produces microwave radiation at selected frequencies from a frequency range. In one implementation, the frequency range can be 10 GHz or less (e.g., 7 GHz or less). The microwave radiation source can be of any design, which allows for one or more wavelengths of microwave radiation to be delivered at a varying frequency to the electrode assembly, which can include the implementations described above. The microwave radiation source can be positioned to deliver microwave radiation to the electrode assembly. Further, the microwave radiation source may be at various angles with reference to the position of the electrode assembly so long as the electrode assembly receives at least portion of the microwave radiation.

The variable microwave radiation raises the temperature of the electrode assembly to a temperature, which improves the moisture removal efficiency of subsequent drying processes. The pre-heat process may also reduce subsequent drying times. In one implementation, the pre-heat process of operation 610 pre-heat the electrode assembly to a temperature in the range of 50 degrees Celsius to about 150 degrees Celsius, such as in the range of 50 degrees Celsius to about 100 degrees Celsius, for example, in the range of 90 degrees Celsius to about 100 degrees Celsius. The temperature is typically dependent on the properties of the electrode assembly and the amount of moisture present in the electrode assembly. Some materials or amounts of moisture may benefit from higher or lower temperatures, thus the variable microwave radiation can be adjusted accordingly.

Without intending to be bound by theory, single frequency microwave radiation is typically inadequate for pre-heating of electrode assemblies. Single frequency microwave radiation can allow energy to accumulate in the materials of the electrode assembly. The use of a variable frequency microwave energy source can prevent the buildup of energy in the layers of the electrode assembly that lead to temperature non-uniformity such as “hot spots.”

At operation 630, the microwave radiation is delivered at a first variable frequency from the source of microwave radiation to the electrode assembly to pre-heat the electrode assembly. The microwave radiation is delivered at a first variable frequency from the source of microwave radiation to the electrode assembly to heat at least the electrode assembly to a pre-heat temperature. The variable frequency of the microwave radiation can include two or more frequencies selected from the frequency range over a first period of time. The variable microwave radiation can be delivered using the parameters described with reference to FIG. 2.

The frequency range of the variable frequency microwave energy 262 can be a specific range of frequencies, such as a range from about 0.9 GHz to about 10 GHz, for example, from about 5.85 GHz to 7.0 GHz, such as from about 5.85 GHz to about 6.65 GHz. In one implementation, the variable frequency microwave energy is in the range of from 5850 MHz to 6650 MHz. Further, the frequency range can be partitioned into frequencies of a specific interval from one another, such as frequencies selected to be separated by from 200 Hz to 280 Hz. In one implementation, a 260 Hz separation in frequencies selected from the variable frequency microwave energy can be used, creating 4096 selected frequencies from which the variable frequency microwave energy can be selected. In another implementation, the frequency range of the variable frequency microwave energy can be a specific range of frequencies, such as a range from about 0.09 GHz to about 0.10 GHz, for example, from about 0.58 GHz to about 0.7 GHz, such as from about 0.58 GHz to about 0.67 GHz. Further, the variable frequency microwave energy delivered during the frequency sweeping can be delivered to the electrode assemblies in short bursts of each frequency range selected, such as short bursts of 10 microseconds to 40 microseconds per frequency, such as short bursts of 20 microseconds to 30 microseconds per frequency. In one implementation, the first period of time is between 1 and 20 minutes, such as between 6 and 10 minutes.

At operation 640, the pre-heated electrode assembly is transferred to a drying region. In some implementations, the pre-heated electrode assembly is transferred from the pre-heat region to the drying region via a load lock region. The load lock region can be the first load lock region 510. For example, in some implementations where the environment of the pre-heat region is maintained at atmospheric pressure, the load lock region eliminates the flow of gases from the atmospheric pressure side of the load lock regions to the vacuum conditions inside the drying region.

At operation 650, the pre-heated electrode assembly is dried in the drying region. In one implementation, the drying region is the first drying region 340 positioned in either the substrate-processing system 300 or the substrate-processing system 500. In one implementation, the environment of the first drying region is maintained as a vacuum environment during the drying process. In one implementation, the first drying region is maintained at a vacuum level (e.g., 200 to 500 Torr) during the drying process.

During operation 650, a source of microwave radiation positioned in the first drying region is directed toward the electrode assembly. The source of microwave radiation produces microwave radiation at selected frequencies from a second frequency range. The second frequency range is typically less that the first frequency range. The second frequency range can be to GHz or less. In one implementation, the second frequency range is 10% to 20% of the first frequency range. The microwave radiation source can be of any design, which allows for one or more wavelengths of microwave radiation to be delivered at a varying frequency to the electrode assembly, which can include the implementations described above. The microwave radiation source can be positioned to deliver microwave radiation to the electrode assembly. Further, the microwave radiation source may be at various angles with reference to the position of the electrode assembly so long as the electrode assembly receives at least portion of the microwave radiation.

In one implementation, the electrode assembly is maintained at the pre-heat temperature during the drying process. In one implementation, the electrode assembly is maintained at a temperature in the range of 50 degrees Celsius to about 150 degrees Celsius, such as in the range of 50 degrees Celsius to about 100 degrees Celsius, for example, in the range of 90 degrees Celsius to about 100 degrees Celsius during the drying process at operation 650.

During operation 650, the microwave radiation is delivered at a second variable frequency from the source of the microwave radiation to the pre-heated electrode assembly to dry the pre-heated electrode assembly to remove residual moisture from the pre-heated electrode assembly. The second variable frequency may comprise two or more frequencies selected from the second frequency range. The second variable frequency may change over a second period of time.

In one implementation, the second frequency range is 10% to 20% of the first frequency range. In one implementation, the second frequency range of the variable frequency microwave energy can be a specific range of frequencies, such as a range from about 0.9 GHz to about 10 GHz, for example, from about 5.85 GHz to 7.0 GHz, such as from about 5.85 GHz to about 6.65 GHz. In one implementation, the variable frequency microwave energy is in the range of from 5850 MHz to 6650 MHz. Further, the frequency range can be partitioned into frequencies of a specific interval from one another, such as frequencies selected to be separated by from 200 Hz to 280 Hz. In one implementation, a 260 Hz separation in frequencies selected from the variable frequency microwave energy can be used, creating 4096 selected frequencies from which the variable frequency microwave energy can be selected. In another implementation, the second frequency range of the variable frequency microwave energy can be a specific range of frequencies, such as a range from about 0.09 GHz to about 0.10 GHz, for example, from about 0.58 GHz to about 0.7 GHz, such as from about 0.58 GHz to about 0.67 GHz. Further, the variable frequency microwave energy delivered during the frequency sweeping can be delivered to the electrode assemblies in short bursts of each frequency range selected, such as short bursts of 10 microseconds to 40 microseconds per frequency, such as short bursts of 20 microseconds to 30 microseconds per frequency. In one implementation, the first period of time is between 1 and 20 minutes, such as between 6 and 10 minutes.

In some implementations, operation 650 further comprises exposing the electrode assembly to heated air. The flow of heated air may be delivered to the electrode assembly to evaporate some or all of the residual moisture from the electrode assembly. If needed, the electrode assembly may be transferred through additional drying regions, such as the second drying region 350 and/or the third drying region 360, until a chosen amount of moisture removal is achieved.

After the drying process of operation 650, the dried electrode assembly is transferred out of the drying region. In one implementation, the dried electrode assembly is transferred from the drying region to an unload region via a load lock region. The load lock region can be the second load lock region 520. For example, in some implementations where the environment of the drying region is maintained at vacuum conditions, the load lock region eliminates the flow of gases from the vacuum side of the load lock region to the atmospheric conditions of the unload region.

In summary, some of the benefits of some of the implementations described herein provide a substrate-processing system and process for increasing throughput and reducing cost of ownership for drying of electrode assemblies, such as a jelly roll-type electrode assembly. In some implementations, the substrate-processing system combines a variable frequency microwave (VFM) source with a vacuum assisted environment and tubular chamber design to achieve improved moisture removal and higher throughput. In some implementations, the walls of the tubular chamber are heated. In some implementations, dedicated chamber racks, which match the form factor of the tubular chamber design, are provided to transport one or more electrode assemblies through the substrate-processing system.

When introducing elements of the present disclosure or exemplary aspects or implementation(s) thereof, the articles “a,” “an,” “the” and “said” are intended to mean that there are one or more of the elements.

The terms “comprising,” “including” and “having” are intended to be inclusive and mean that there may be additional elements other than the listed elements.

While the foregoing is directed to implementations of the present disclosure, other and further implementations of the disclosure may be devised without departing from the basic scope thereof, and the scope thereof is determined by the claims that follow.

1. A system for moisture removal, comprising:
a tubular chamber body defining one or more processing regions, the tubular chamber body comprising:
a tubular outer wall; and
an interior wall that encloses an interior volume, wherein the one or more processing regions include:
a pre-heat region, comprising:
a first variable frequency microwave source capable of producing microwave energy in a range from about 0.9 GHz to about 10.0 GHz; and
a drying region, comprising:
a second variable frequency microwave source capable of producing microwave energy in a range from about 0.9 GHz to about 10.0 GHz; and
a vacuum source.

2. The system of claim 1, wherein the one or more processing regions further include a first load lock region positioned between the pre-heat region and the drying region.

3. The system of claim 2, further comprising a first vacuum tight gate valve positioned between the pre-heat region and the first load lock region.

4. The system of claim 3, further comprising a second vacuum tight gate valve positioned between the first load lock region and the drying region.

5. The system of claim 3, wherein the one or more processing regions further include a second load lock region positioned after the drying region.

6. The system of claim 1, wherein the one or more processing regions further include a load lock region positioned before the pre-heat region.

7. The system of claim 6, further comprising a vacuum tight gate valve positioned between the pre-heat region and the load lock region.

8. The system of claim 1, further comprising a conveyor system extending along a longitudinal axis of the tubular chamber body for transferring one or more substrates between the pre-heat region and the drying region.

9. The system of claim 1, wherein the tubular chamber body includes a temperature control apparatus.

10. The system of claim 9, wherein the temperature control apparatus is a heat source.

11. A method for processing a substrate, comprising:
performing a pre-heat of a jelly roll-type electrode assembly in a pre-heat region of a tubular processing system, the pre-heat region comprising:
directing a source of microwave radiation toward the jelly roll-type electrode assembly, the source of microwave radiation producing microwave radiation at a first frequency selected from a first frequency range of from about 0.9 GHz to about 10.0 GHz; and
delivering the microwave radiation at a first variable frequency from the source of microwave radiation to the jelly roll-type electrode assembly to pre-heat the jelly roll-type electrode assembly to a pre-heat temperature, the first variable frequency comprising two or more frequencies selected from the first frequency range, the first variable frequency changing over a first period of time.

12. The method of claim 11, wherein the pre-heat temperature is between about 90 degrees Celsius and about 100 degrees Celsius.

13. The method of claim 11, wherein the first frequency range is from about 5850 MHz to about 6650 MHz.

14. The method of claim 11, wherein the first variable frequency comprises two or more frequencies, each frequency varying from a previous frequency by from about 200 MHz to about 280 MHz.

15. The method of claim 11, wherein the first variable frequency change occurs during the first period of time in a time interval of from about 20 microseconds to about 30 microseconds.

16. A method for processing a substrate, comprising:
performing a pre-heat of a jelly roll-type electrode assembly in a pre-heat region of a tubular processing system, the pre-heat region comprising:
directing a first source of microwave radiation toward the jelly roll-type electrode assembly, the first source of microwave radiation producing microwave radiation at a first frequency selected from a first frequency range of from about 0.9 GHz to about 10.0 GHz; and
delivering the microwave radiation at a first variable frequency from the first source of microwave radiation to the jelly roll-type electrode assembly to pre-heat the jelly roll-type electrode assembly to a pre-heat temperature, the first variable frequency comprising two or more frequencies selected from the first frequency range, the first variable frequency changing over a first period of time; and
performing a drying of the pre-heated jelly roll-type electrode assembly in a drying region of the tubular processing system, the drying comprising:
directing a second source of microwave radiation toward the pre-heated jelly roll-type electrode assembly, the second source of microwave radiation producing microwave radiation at a second frequency selected from a second frequency range less than the first frequency range; and
delivering the microwave radiation at a second variable frequency from the second source of the microwave radiation to the pre-heated jelly roll-type electrode assembly to dry the pre-heated jelly roll-type electrode assembly to remove residual moisture from the pre-heated jelly roll-type electrode assembly, the second variable frequency comprising two or more frequencies selected from the second frequency range, the second variable frequency changing over a second period of time.

17. The method of claim 16, wherein the pre-heated jelly roll-type electrode assembly is maintained at a temperature between about 90 degrees Celsius and about 100 degrees Celsius during the drying.

18. The method of claim 16, wherein the second frequency range is in a range that is from about 10% to 20% of the range of the first frequency range.

19. The method of claim 16, wherein the second variable frequency comprises two or more frequencies, each frequency varying from a previous frequency by from about 200 MHz to about 280 MHz.

20. The method of claim 16, wherein performing the drying of the pre-heated jelly roll-type electrode assembly in the drying region of the tubular processing system is performed in a vacuum environment.
